(19) United States
(12) Patent Application Publication
(10) Pub. No.: US 2004/0239062 A1
(43) Pub. Date: Dec. 2, 2004

(54) Stroller with a rotatable seat disposed rotatably on a stroller frame through bearings and connected fixedly to a fork member

(76) Inventor: Red Lan, Taipei Hsien (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/447,945

(22) Filed: May 30, 2003

(51) Int. Cl. B62B 7/00

(52) U.S. Cl. 280/47.38

(57) ABSTRACT

A stroller includes a stroller frame, a wheel seat connected fixedly to the stroller frame, a mounting seat disposed under and connected fixedly to the wheel seat so as to define an accommodating chamber between the wheel seat and the mounting seat. A rotatable seat is disposed between two bearings that are disposed within the accommodating chamber, and is connected fixedly to a fork member of a wheel unit so as to permit rotation of the wheel unit about a vertical axis.

### BACKGROUND OF THE INVENTION

1. Field of the Invention

This invention relates to a stroller, and more particularly to a stroller that includes a rotatable seat which is disposed rotatably on a stroller frame by use of bearings and which is connected fixedly to a fork member.

2. Description of the Related Art

Referring to FIGS. 1 and 2, a first conventional stroller 1 is shown to include a stroller frame 11, a front wheel unit 12, a direction-fixing mechanism 13, and two rear wheels 14 disposed rotatably on a rear portion of the stroller frame 11. The stroller frame 11 includes left and right bars 111, an upright tube 112 disposed fixedly between front ends of the left and right bars 111, and a bushing 114 disposed within a central hole 113 in the upright tube 112 and having a bottom surface that is formed with a hole 115. The front wheel unit 12 includes a wheel 121, a fork member 122, and a horizontal axle 123 journalled on the fork member 122. The fork member 122 has a coupling portion 124 that extends into the hole 115 in the bushing 114 and that is formed with an annular groove 125, which has a positioning groove portion 126 that extends radially and inwardly therefrom.

The direction-fixing mechanism 13 includes a mounting tube 131 connected fixedly to and extending radially and outwardly from the upright tube 112, a rotatable element 132 connected threadedly to the mounting tube 131, and an insert pin 133 that is connected fixedly to the rotatable element 132 and that can be inserted into the positioning groove portion 126 of the annular groove 125 in the fork member 122 so as to prevent rotation of the fork member 122 relative to the stroller frame 11.

Although the front wheel unit 12 can rotate about the coupling portion 124 of the fork member 122, friction is generated between the coupling portion 124 and the bushing 114, thereby resulting in unsmooth rotation of the fork member 122 and wear between the coupling portion 124 and the bushing 114.

To solve this problem, referring to FIG. 3, in a second conventional stroller, bearings 23, 24 are provided on a wheel unit 2 that includes a wheel seat 21 and a wheel 22. The wheel seat 21 has two wings 211, between which the wheel 22 is disposed, and a seat body 212 formed integrally with upper ends of the wings 211 and disposed between the bearings 23, 24. A vertical pivot shaft 25 extends through the bearings 23, 24 and the seat body 212. Because the seat body 212 can rotate relative to the vertical pivot shaft 25, the weight of a baby seated on the stroller will cause uneven stress distribution over the wheel unit 2, which can result in deformation of the components of the wheel unit 2.

### SUMMARY OF THE INVENTION

The object of this invention is to provide a stroller that includes a wheel unit that is connected to a stroller frame so that stress can be distributed uniformly over the wheel unit when a baby sits on the stroller.

According to this invention, a stroller comprises a stroller frame and a wheel seat unit including a wheel seat that is connected fixedly to the stroller frame, and a mounting seat that is disposed under and that is connected fixedly to the wheel seat so as to define an accommodating chamber between the front wheel seat and the mounting seat. A direction-changing mechanism is disposed within the accommodating chamber, and includes a first bearing, a second bearing disposed under the first bearing, and a rotatable seat disposed between the first and second bearings so as to permit rotation of the rotatable seat about a vertical axis within the accommodating chamber. A wheel unit includes a fork member that is formed with two upright fork blades and that is connected fixedly to the rotatable seat so as to rotate relative to the stroller frame, and a wheel disposed rotatably between the fork blades. Because the rotatable seat is connected fixedly to the fork member, when a baby sits on the stroller, stress can be distributed uniformly over the wheel unit.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a first conventional stroller;

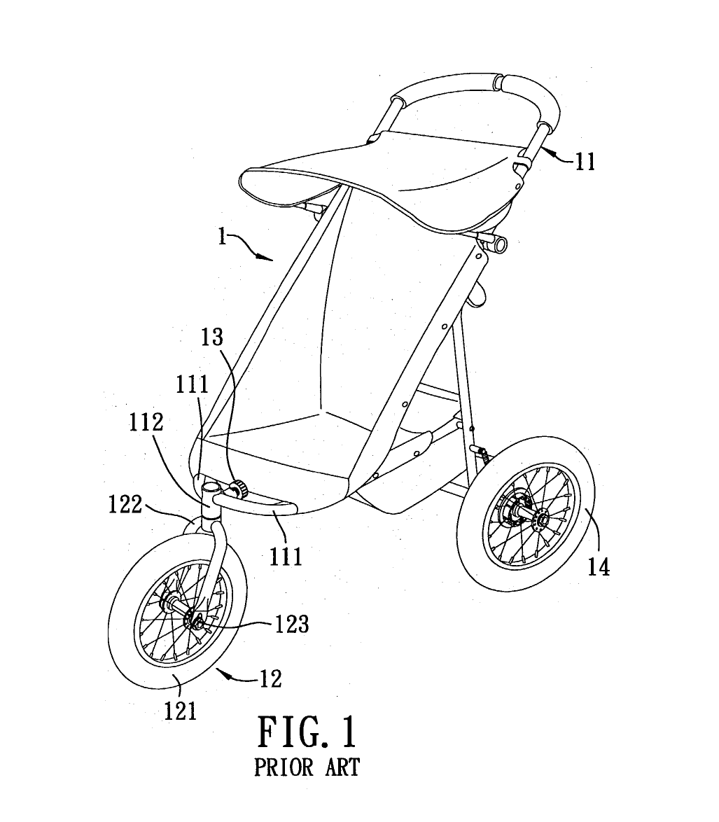

FIG. 2 is fragmentary sectional view of the first conventional stroller, illustrating how a fork member is connected to a stroller frame;

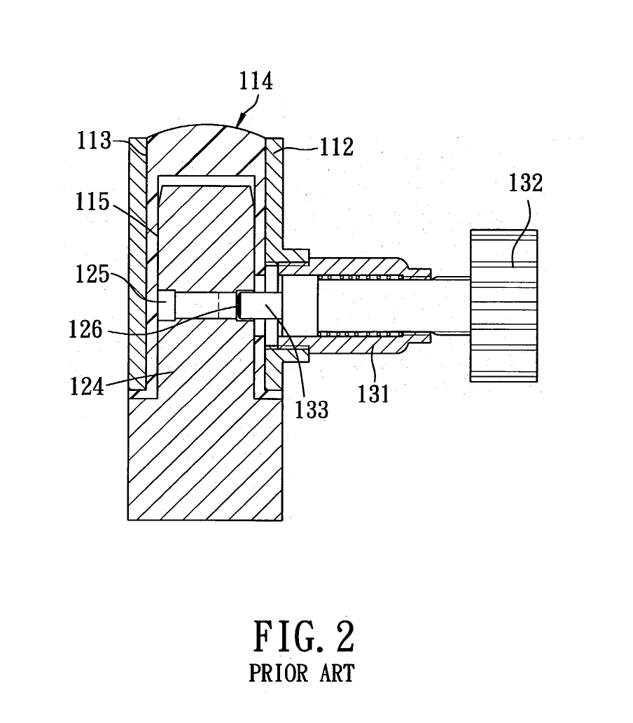

FIG. 3 illustrates a wheel unit of a second conventional stroller;

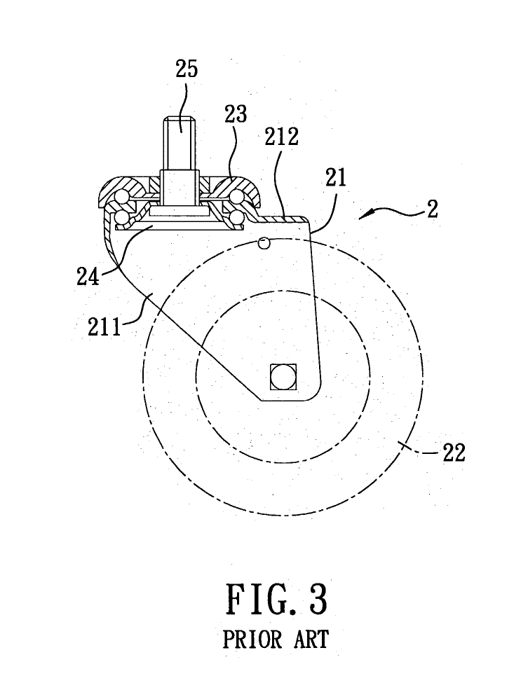

FIG. 4 is an assembled perspective view of the preferred embodiment of a stroller according to this invention;

FIG. 5 is a fragmentary sectional view of the preferred embodiment, illustrating a structural connection among a wheel seat unit, a direction-changing mechanism, and a wheel unit;

FIG. 6 is an exploded fragmentary perspective view of the preferred embodiment;

FIG. 7 is a partly sectional, fragmentary perspective view of the preferred embodiment; and

FIG. 8 is a fragmentary perspective view of the preferred embodiment, illustrating how the direction of the wheel unit is changed.

### DETAILED DESCRIPTION OF THE PREFERRED EMBODIMENT

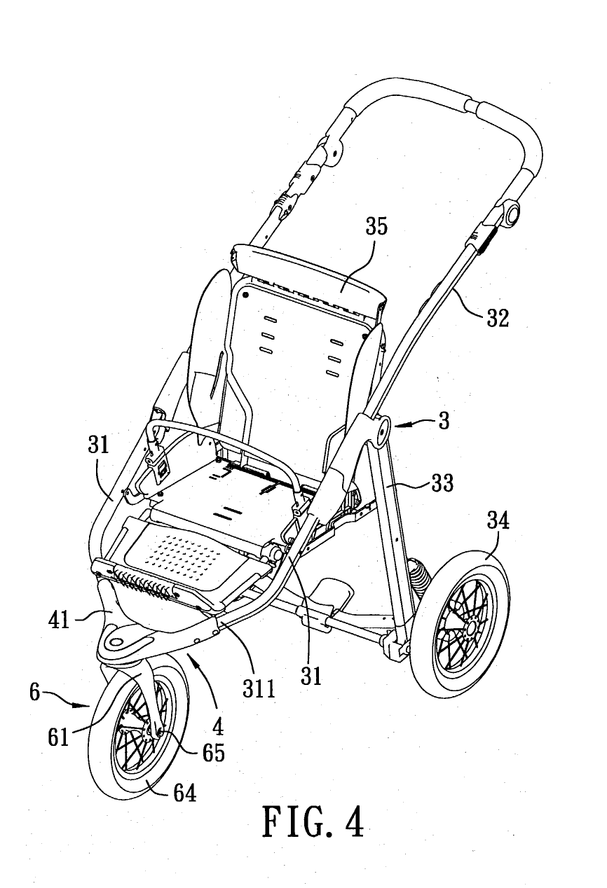

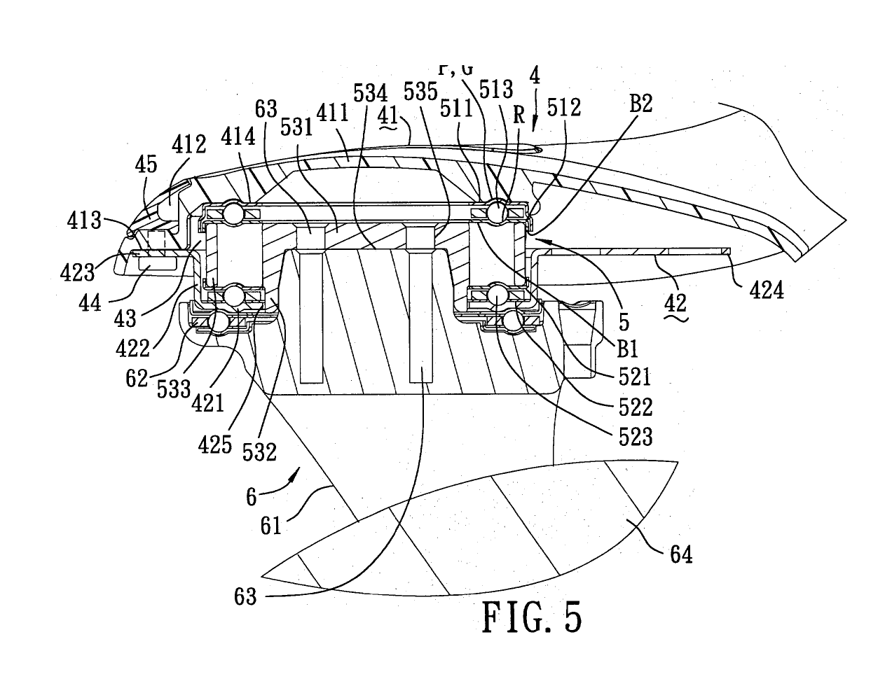

Referring to FIGS. 4, 5, and 6, the preferred embodiment of a stroller according to this invention is shown to include a stroller frame 3, a wheel seat unit 4, a direction-changing mechanism 5, and a wheel unit 6.

The stroller frame 3 includes inclined left and right bars 31, an inverted U-shaped hand-push handle 32, and two upright rear bars 33. Two rear wheels 34 are disposed on the rear bars 33, respectively. A seat unit 35 is disposed between the bars 31. Each of the bars 31 has a mounting end 311.

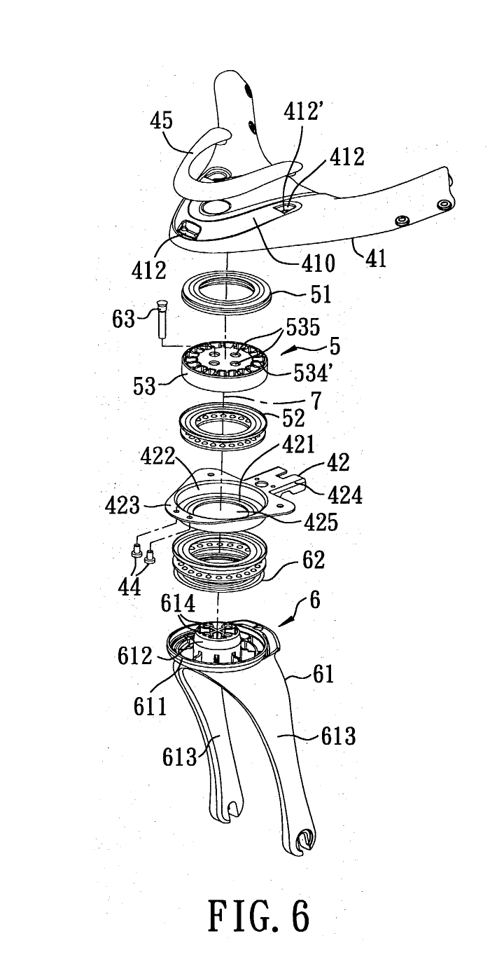

The wheel seat unit 4 includes a wheel seat 41 that is connected fixedly to the mounting ends 311 of the bars 31, a mounting seat 42 that is disposed under and that is connected to the wheel seat 41 so as to define an accommodating chamber 43 between the wheel seat 41 and the mounting seat 42, a plurality of bolts 44 for connecting the mounting seat 42 fixedly to the wheel seat 41, and a filler 45 fitted within a U-shaped groove 410 in the wheel seat 41. The wheel seat 41 has a base wall 411 that has three indented portions 412, each of which is formed with a threaded hole 412′ (see FIG. 6) therethrough, an annular flange-engaging surface 413 that faces the mounting seat 42, and an annular bearing-engaging surface 414 that is located above the flange-engaging surface 413 and that is formed with an annular groove unit (G). The U-shaped groove 410 extends in top surfaces of the indented portions 412. The threaded holes 412′ have lower ends that are formed in the flange-engaging surface 413.

The mounting seat 42 has an annular bottom ball 421, a surrounding wall 422 extending integrally and upwardly from an outer periphery of the bottom wall 421, three outwardly extending horizontal flanges 423 that abut against the flange-engaging surface 413 of the wheel seat 41, a direction-fixing element 424, and a central hole 425 defined by the bottom wall 421. Because the function of the direction-fixing element 424 is not pertinent to the claimed invention, a detailed description thereof is omitted herein for the sake of brevity. The accommodating chamber 43 is located among the bearing-engaging surface 414 of the wheel seat 41, the surrounding wall 422, and the bottom wall 421. The bolts 44 extend respectively through the flanges 423, and engage respectively the threaded holes 412′ so as to connect the mounting seat 42 fixedly to the wheel seat 41.

The direction-changing mechanism 5 is disposed within the accommodating chamber 43, and includes a first bearing 51, a second bearing 52 disposed under the first bearing 51, and a rotatable seat 53 disposed between the first and second bearings 51, 52 so as to permit rotation of the rotatable seat 53 about a vertical axis 7 (see FIG. 6) within the accommodating chamber 43. Each of the first and second bearings 51, 52 is constructed in a known manner, and includes a horizontal upper race 511, 521 with a ball-receiving unit (R), a horizontal lower race 512, 522 disposed under the upper race 511, 521 and having a ball-receiving unit (R), and a plurality of balls 513, 523 disposed between the upper and lower races 511, 521, 512, 522 and received within the ball-receiving units (R) in the upper and lower races 511, 521, 512, 522. The upper race 511 of the first bearing 51 is formed with an annular projection unit (P) that is aligned with the ball-receiving unit (R) of the upper race 511 of the first bearing 51. The upper race 511 of the first bearing 51 abuts against the bearing-engaging surface 414 of the wheel seat 41. The projection unit (P) of the first bearing 51 engages the annular groove unit (G) in the bearing-engaging surface 414 so as to position the first bearing 51 relative to the wheel seat 41. Similarly, the lower race 522 is positioned on the bottom wall 421 of the mounting seat 42.

The rotatable seat 53 includes a horizontal circular central plate 531, an annular inner surrounding plate 532 extending integrally and downwardly from an outer periphery of the central plate 531 so as to define a cylindrical chamber 534 within the inner surrounding plate 532 and under the central plate 531, an outer surrounding plate 533 disposed around the inner surrounding plate 532, and a plurality of angularly equidistant radial ribs 534′ (see FIG. 6) that are formed integrally with the inner and outer surrounding plates 532, 533. The lower race 512 of the first bearing 51 has an annular horizontal top wall (B1) that abuts against upper ends of the outer surrounding plate 533 and the ribs 534′, and a surrounding wall (B2) that extends integrally and downwardly from an outer periphery of the top wall (B1) and that is disposed around the outer surrounding plate 533. The central plate 531 of the rotatable seat 53 has a plurality of holes 535 formed therethrough, which are spaced apart from the vertical axis 7 (see FIG. 6) by the same distance.

The wheel unit 6 includes a fork member 61, a third bearing 62, a plurality of headed coupling posts 63, a wheel 64, and an axle assembly 65. The fork member 61 has an upper fork portion 611, an upwardly extending cylinder 612 formed integrally with a central portion of the upper fork portion 611 and received fittingly and rotatably within the cylindrical chamber 534 in the rotatable seat 53, two upright fork blades 613 extending downwardly from the upper fork portion 611, and a plurality of holes 614 formed in a top surface of the cylinder 612. The third bearing 62 is disposed between the mounting seat 42 and the fork member 61. The coupling posts 63 extend respectively through the holes 535 in the rotatable seat 53, and are fixed respectively within the holes 614 in the cylinder 612 of the fork member 61 so as to interconnect fixedly the rotatable seat 53 and the fork member 61. As such, the fork member 61 can rotate about the vertical axis 7. The wheel 64 is disposed rotatably between the fork blades 613.

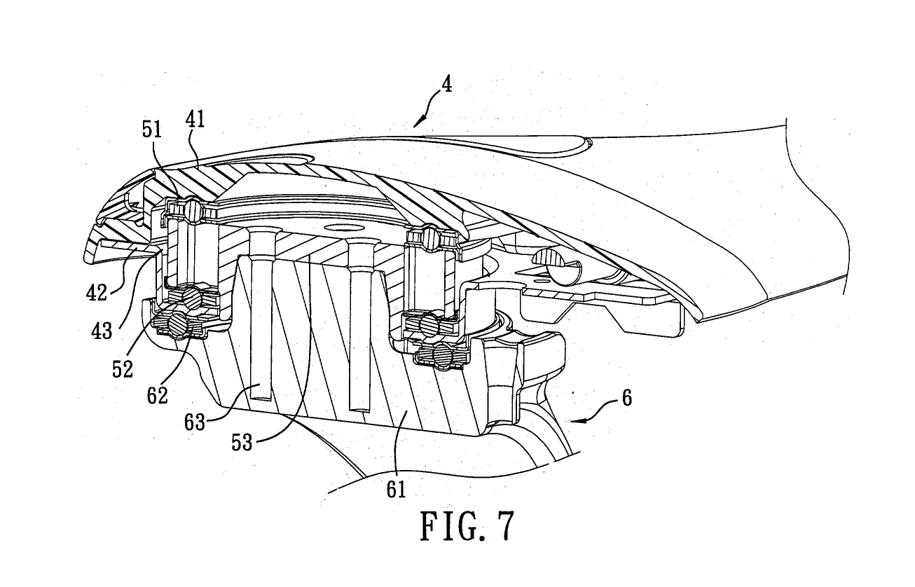

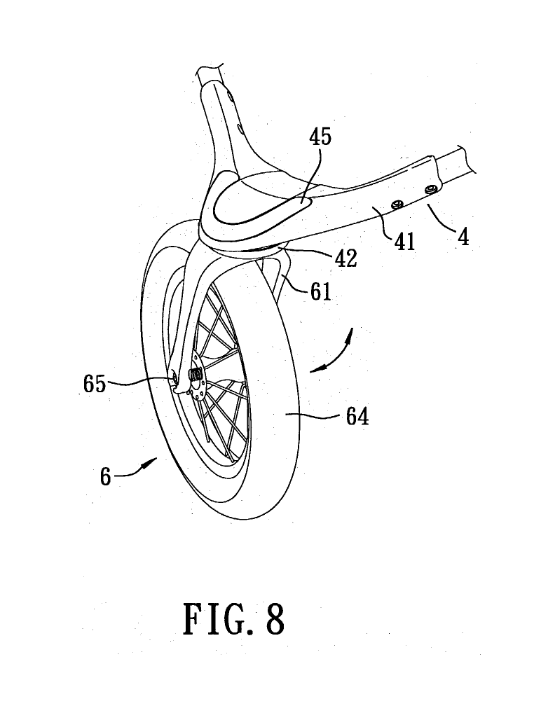

Referring to FIGS. 7 and 8, when the direction of the wheel 64 is changed, because the rotatable seat 53 is mounted to the wheel seat 41 through the first bearing 51, to the mounting seat 42 through the second bearing 52, and to the wheel unit 6 through the third bearing 62, the rotation of the fork member 61 is relatively smooth, and is easily controllable. Furthermore, because the fork member 61 is connected fixedly to the rotatable seat 53 by means of the coupling posts 63 and because the wheel unit 6 is rotatable about the vertical axis 7, when a baby sits on the stroller, stress can be distributed uniformly over the wheel unit 6 so as to reduce deformation of the components of the same, thereby increasing the life of the stroller.

With this invention thus explained, it is apparent that numerous modifications and variations can be made without departing the scope and spirit of this invention. It is therefore intended that this invention be limited only as indicated by the appended claims.

I claim:

1. A stroller comprising:
a stroller frame;
a wheel seat unit including a wheel seat that is connected fixedly to said stroller frame, and a mounting seat that is disposed under and that is connected fixedly to said wheel seat so as to define an accommodating chamber between said wheel seat and said mounting seat;
a direction-changing mechanism disposed within said accommodating chamber and including a first bearing, a second bearing disposed under said first bearing, and a rotatable seat disposed between said first and second bearings so as to permit rotation of said rotatable seat about a vertical axis within said accommodating chamber; and
a wheel unit including a fork member that is formed with two upright fork blades and that is connected fixedly to said rotatable seat so as to rotate relative to said stroller frame, and a wheel disposed rotatably between said fork blades.

2. The stroller as claimed in claim 1, wherein said wheel unit further includes at least two spaced-apart coupling posts for interconnecting fixedly said rotatable seat and said fork member.

3. The stroller as claimed in claim 2, wherein said coupling posts are spaced apart from the vertical axis by the same distance.

4. The stroller as claimed in claim 1, wherein said wheel unit further includes a third bearing that is disposed between said mounting seat and said fork member.

5. The stroller as claimed in claim 1, wherein each of said first and second bearings includes a horizontal upper race with a ball-receiving unit in a bottom surface thereof, a horizontal lower race disposed under said upper race and having a ball-receiving unit, and a plurality of balls disposed between said upper and lower races and received within said ball-receiving units in said upper and lower races.

6. The stroller as claimed in claim 5, wherein said upper race of said first bearing has an annular projection unit that is formed on a top surface thereof and that is aligned with said ball-receiving unit of said upper race of said first bearing, said wheel seat having an annular bearing-engaging surface that abuts against said upper race of said first bearing and that is formed with an annular groove unit which engages said annular projection unit of said upper race of said first bearing.

7. The stroller as claimed in claim 1, wherein said wheel seat has a base wall that has three indented portions, each of which is formed with a threaded hole therethrough, and an annular flange-engaging surface that faces said mounting seat, said threaded holes having lower ends that are formed in said flange-engaging surface, said mounting seat being formed with three outwardly extending horizontal flanges that abut against said flange-engaging surface of said wheel seat, said wheel seat unit further including three bolts that extend respectively through said flanges of said mounting seat and that engage respectively said threaded holes in said wheel seat so as to interconnect fixedly said wheel seat and said mounting seat.

8. The stroller as claimed in claim 1, wherein said rotatable seat includes a horizontal circular central plate, and an annular inner surrounding plate extending integrally and downwardly from an outer periphery of said central plate so as to define a cylindrical chamber within said inner surrounding plate and under said central plate, said fork member being formed with an upwardly extending cylinder that is received fittingly and rotatably within said cylindrical chamber in said rotatable seat.

9. The stroller as claimed in claim 8, wherein said central plate of said rotatable seat has a plurality of holes formed therethrough, said cylinder of said fork member having a top surface that is formed with a plurality of holes, said wheel unit further including a plurality of headed coupling posts extending respectively through said holes in said rotatable seat and fixed within said holes in said cylinder of said fork member so as to interconnect fixedly said rotatable seat and said fork member.

10. The stroller as claimed in claim 8, wherein said rotatable seat further includes an outer surrounding plate disposed around said inner surrounding plate, and a plurality of angularly equidistant radial ribs that are formed integrally with said inner and outer surrounding plates, said lower race of said first bearing having an annular horizontal top wall that abuts against upper ends of said outer surrounding plate and said ribs, and a surrounding wall that extends integrally and downwardly from an outer periphery of said top wall and that is disposed around said outer surrounding plate.

11. The stroller as claimed in claim 1, wherein said fork member is formed with an upwardly extending cylinder that extends through said mounting seat and said second bearing and that is connected fixedly to said rotatable seat.
